(19) United States
(12) Patent Application Publication
(10) Pub. No.: US 2014/0254126 A1
(43) Pub. Date: Sep. 11, 2014

(54) LIGHTING APPLIANCE HAVING A HANDLE FOR ADJUSTING THE ILLUMINATION

(71) Applicant: MAQUET SAS, ARDON (FR)

(72) Inventors: Lionel COMTE, LA CHAPELLE SAINT MESMIN (FR); Robin JOUSSE, LA CHAPELLE SAINT MESMIN (FR); Stéphane LEGRAND, DONNERY (FR)

(21) Appl. No.: 14/196,644

(22) Filed: Mar. 4, 2014

(30) Foreign Application Priority Data
Mar. 5, 2013 (FR) 1351964

(51) Int. Cl. F21V 14/02

(52) U.S. Cl. CPC F21V 14/02; F21W 2131/205
USPC 362/33

(57) ABSTRACT

A lighting appliance (1), in particular for illuminating an operating field (4), comprises a light module (8) having a handle (11) mounted to turn, and a monitoring and control unit (10) that responds to said handle (11) turning by acting on an adjustment setting of said lighting appliance (1), and the monitoring and control unit (10) is arranged to read, at successive regular time intervals, an indication of the relative angular position of the handle (11), and to act on the adjustment setting on the basis of the indications of the current relative angular position and of the preceding relative angular position that are read respectively for a current time interval and for a time interval immediately preceding the current time interval.

### TECHNICAL FIELD

The invention relates generally to a lighting appliance, and more particularly to a lighting appliance used in an operating theater for illuminating an operating field.

### PRIOR ART

In known manner, a lighting appliance comprises a light module having one or more light sources connected to an electrical power supply controlled by a monitoring and control unit.

The light module can be provided with a handle for moving it. The handle can be further mounted to turn about its longitudinal axis so as to deliver an angular position signal that is used by the illumination monitoring and control unit for adjusting the illumination, e.g. for adjusting the brightness of the illumination.

Patent Document US 2006/0109650 describes such a lighting appliance in which the handle is coupled to a differential transducer outputting an electrical signal that depends on the angular position of the handle and that makes it possible to modulate the power of the illumination as a function of that position. The turning of the handle is unlimited and is said to be “endless”.

Such lighting is generally carried by an articulated arm enabling the illumination to be steered in three dimensions. Thus, the handle is also used by the medical staff to steer the illumination relative to the operating field. It is therefore important to make sure that acting on the handle to move the illumination does not unintentionally cause the illumination power to be modulated.

To this end, Patent Document EP 2 159 485 describes a lighting appliance in which turning the handle causes the size of the field of illumination to vary, that lighting appliance having two angular abutments limiting the extent to which the handle can be turned. Each abutment is associated with a mechanical sensor making it possible to detect contact between the handle and one or the other of the abutments. The variation in the size of the field of illumination is thus dependent on such contact being detected. As a result, the handle can be used to steer the illumination with little risk of that leading to an unintentional change in the field of illumination. However, that arrangement has functional possibilities that remain limited.

Documents US 2012/043915 and EP 2 065 634 also disclose medical lighting devices provided with handles for adjusting the illumination with precision. However, those adjustments do not depend on predetermined parameters.

### SUMMARY OF THE INVENTION

An object of the invention is to remedy those drawbacks by proposing a lighting appliance provided with a handle that, when turned, makes it possible to adjust the illumination with precision, without physical abutments and while allowing the illumination to be moved by pulling on the handle without any risk of adjusting the illumination in untimely manner.

To this end, the invention provides a lighting appliance, in particular for illuminating an operating field, the lighting appliance comprising a light module having a handle mounted to turn, and a monitoring and control unit that responds to the handle turning by acting on an adjustment setting of the lighting appliance, said lighting appliance being characterized in that the monitoring and control unit is arranged to read, at successive regular time intervals, an indication of the relative angular position of the handle, and to act on the adjustment setting on the basis of the indications of the current relative angular position and of the preceding relative angular position that are read respectively for a current time interval and for a time interval immediately preceding the current time interval, and in that the monitoring and control unit is arranged to compute a current angular difference on the basis of the indications of the current angular position and of the preceding angular position, and to compare the current angular difference with a predetermined threshold.

The general idea lying behind the invention is thus to adjust the illumination on the basis of detection of the relative angular positions of the handle respectively on two consecutive time intervals.

The lighting appliance of the invention may, in particular present the following features:

the monitoring and control unit is arranged to modify the value of an adjustment parameter of the lighting appliance when the current angular difference is greater than the threshold;

the monitoring and control unit is arranged to determine, at each current time interval, a direction for the current angular difference and to increase or to decrease the value of the adjustment parameter as a function of the direction of the current angular difference;

the monitoring and control unit is arranged to compare the current angular difference with a predetermined first threshold for a first turning direction of the handle, and to compare the current angular difference with a predetermined second threshold for a second turning direction of the handle that is opposite from the first turning direction, the first threshold being different from the second threshold;

the monitoring and control unit is arranged to detect a change of turning direction of the handle during the current time interval and the preceding time interval, and to respond to the detection by changing over the adjustment of the lighting appliance from a current adjustment parameter to a predetermined adjustment parameter;

the value of the adjustment parameter is an illumination power, a color temperature, or a light spot size;

the monitoring and control unit changes over from a current adjustment parameter to another adjustment parameter following a predetermined circular list of adjustment parameters;

the lighting appliance has a toothed wheel that is on the same axis as the handle and that is constrained to turn with the handle, a pinion arranged to mesh with the toothed wheel, and a relative angular position sensor suitable for detecting the relative angular position of the handle via the relative angular position of the pinion;

the angular position sensor is of the potentiometer type; and

the handle is hollow and is suitable for receiving a video connector support.

This arrangement of the monitoring and control unit makes it possible to avoid untimely modulations in the adjustment parameter(s) that can be triggered by the handle turning a little when said handle is used for moving the illumination.

In addition, with this arrangement, it is not necessary to know precisely the absolute angular position of the handle because a relative angle of turning is used. The lighting appliance of the invention thus operates in relative manner and not in absolute manner.

In addition, by adjusting the value(s) of the threshold(s), it is possible to act on the sensitivity of the adjustment control, e.g. so as to adapt it to suit each user.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a diagrammatic perspective view of a lighting appliance of the invention that is used in an operating theater;

FIG. 2 is a perspective view of a portion of the handle of the lighting appliance of the invention;

FIG. 3 is an exploded perspective view of the handle of the lighting appliance of the invention shown in a first configuration of use;

FIG. 4 is an exploded perspective view of a portion of the handle shown in a second configuration of use;

FIGS. 5 and 6 are plan views of the handle of FIG. 3 shown in two distinct angular positions;

FIG. 7 is a view similar to FIGS. 5 and 6, showing the handle of FIG. 4;

FIG. 8 is a diagrammatic view of the steps of the stage of switching ON the lighting appliance of the invention; and

FIG. 9 is a diagrammatic view of the steps of the n^{th} loop for modulating the illumination by means of the lighting appliance of the invention.

### DESCRIPTION OF EMBODIMENTS

With reference to FIG. 1, the lighting appliance 1 of the invention is, in particular, designed to be used in the medical field, e.g. in an operating theater 2, for forming an illumination spot 3 (shown diagrammatically by shading) on an operating field 4.

In known manner, the lighting appliance 1 has a base that is fastened to the ceiling of the operating theater 2 and from which an articulated arm 6 extends that carries a lighting dome 7 that houses light sources 8 (shown diagrammatically in dashed lines in FIG. 1), that are part of one or more light modules, such as light-emitting diodes (LEDs) disposed in a ring configuration.

The LEDs 8 are connected electrically to an electrical power supply 9 coupled to a monitoring and control unit 10 suitable for controlling the electrical power supply 9 so as to modulate one or more adjustment parameters, e.g. the size of the illumination spot 3, or indeed the intensity of the light produced by the LEDs 8.

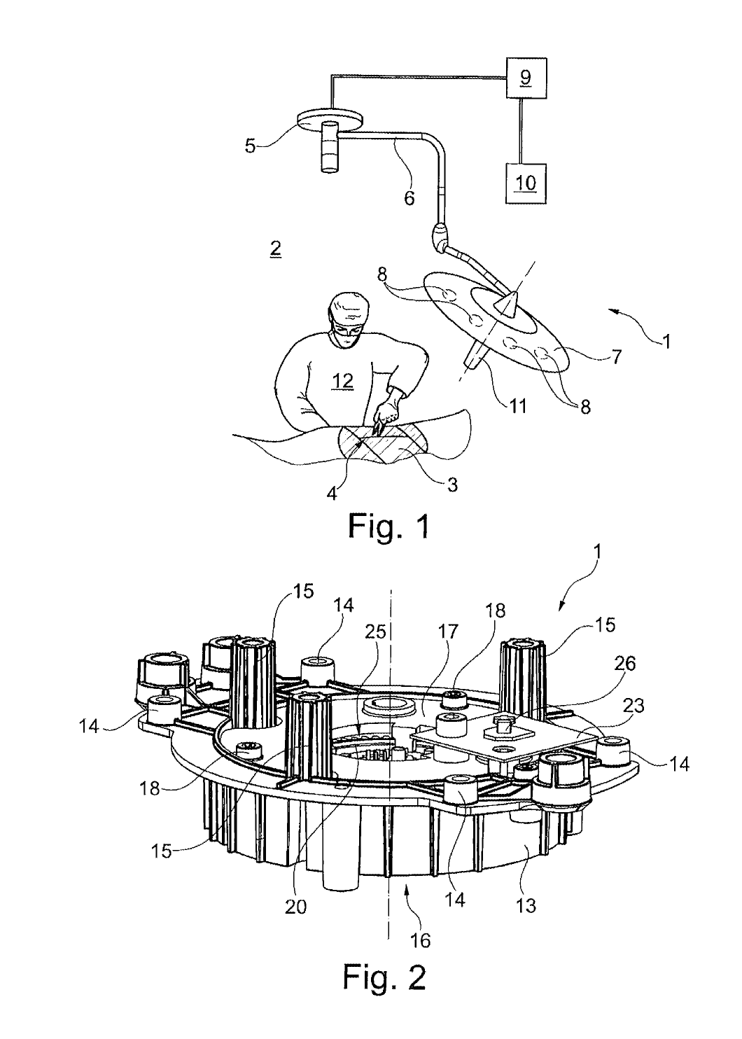

The lighting appliance 1 is also provided with a handle 11 that is on the same axis as the ring of LEDs 8 and that extends axially in the lighting dome 7 so as to be grasped easily by the medical staff 12. Said handle 11 is carried by the lighting dome 7 via a support 13 that can be seen in FIGS. 2 to 4 and that, for that purpose, is provided with orifices 14 and with fastening rods 15 suitable for receiving screws (not shown) or for receiving any other suitable fastening element.

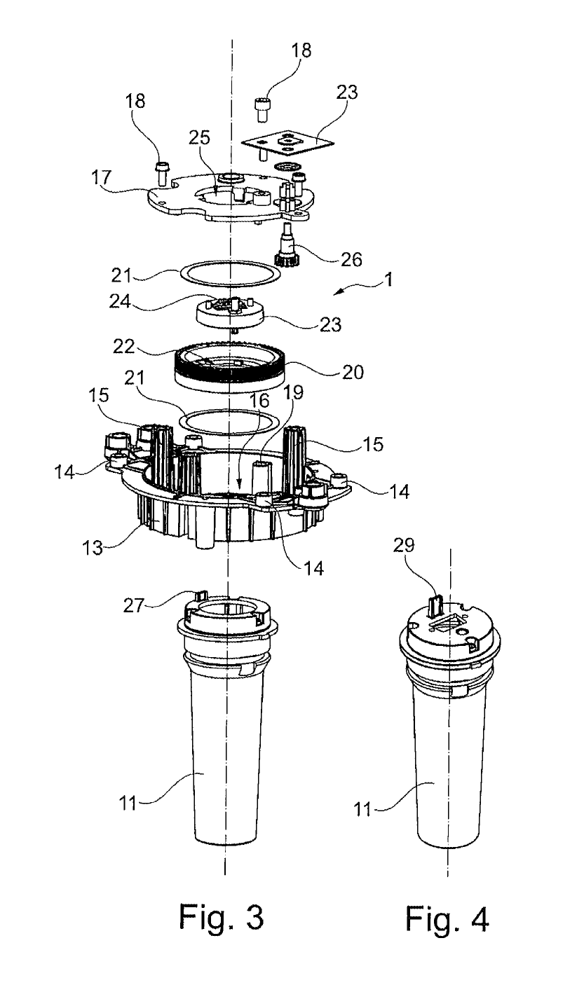

In accordance with the invention, and with reference to FIGS. 2 and 3, the support 13 is in the shape of a dished collar through which a passage 16 extends, allowing the handle 11 to pass through it. The handle 11 is mounted on the support 13 via any known suitable means allowing the handle 11 to turn relative to the support 13. The dished collar is closed by a plate 17 fastened to the support 13, e.g. by means of screws 18 and of tapped orifices 19. The lighting appliance 1 of the invention is provided with a toothed wheel 20 that is on the same axis as the handle 11. The toothed wheel 20 is in the shape of a ring and it is received in the dished collar of the support 13. The toothed wheel 20 is separated from the support 13 and from the plate 17 by washers 21 that are on the same axis and that limit the friction. The toothed wheel 20 has an internal bore 22 in which a video connector support 23 can be received that is suitable for carrying a camera (not shown), and that is provided with electrical connectors 24 for connecting the camera to the electrical power supply 9.

In accordance with the invention, the handle 11 is axially hollow, thereby allowing the camera to pass through so that it can film the operating field 4, or allowing any equivalent electrical instrument to pass through. The plate 17 is also provided with a passage 25 allowing the electrical power supply wires (not shown) of the camera to pass through.

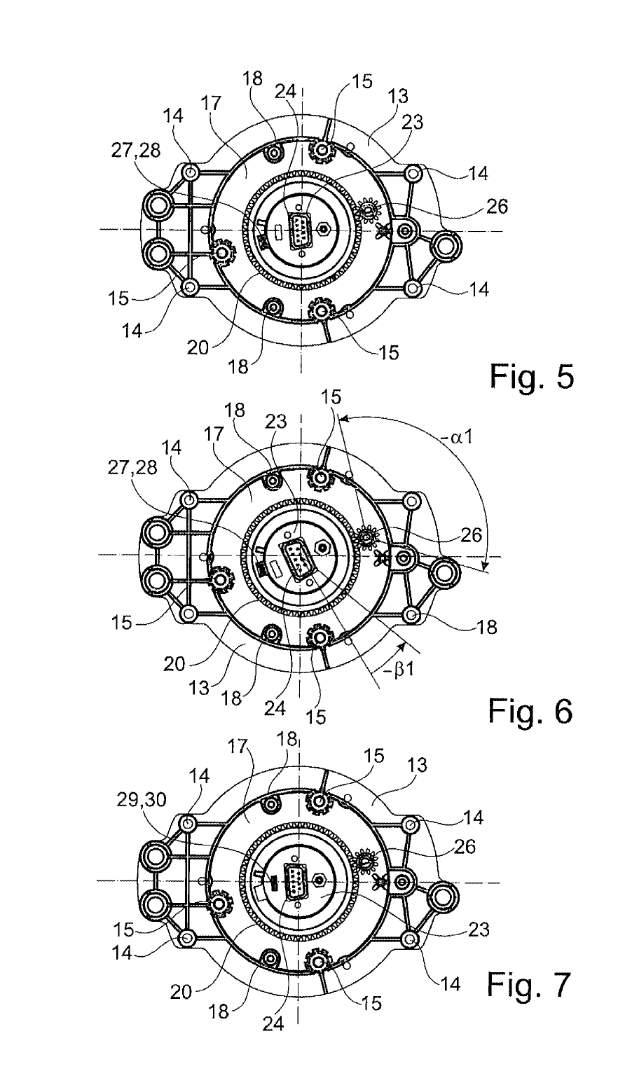

With reference to FIGS. 3 to 7, the lighting appliance 1 of the invention further includes a pinion 26 housed in the dished collar of the support 13 and having its axle carried by the support 13. The pinion 26 is disposed in such a manner as to be in the same plane as the toothed wheel 20 with which it meshes. The ratio between the number of teeth of the toothed wheel 20 relative to the number of teeth of the pinion 26 may, for example, be five. The axle of the pinion 26 passes through the plate 17 via an orifice provided for this purpose. Thus, as shown in FIGS. 5 and 6, when the handle 11 and the toothed wheel 20 turn through an angle of −β1, the pinion 26 turns through an angle of −α1.

With reference to FIGS. 3, 5, and 6, the handle 11 is, in this example, provided with a first lug 27 and the toothed wheel 20 is provided with a first notch 28 suitable for receiving the first lug 27 and for co-operating therewith so that, by turning, the handle 11 drives the toothed wheel 20 in turning. Naturally, this configuration may be inverted, the toothed wheel being provided with the first lug and the handle being provided with the first notch. This configuration makes it possible to modulate an adjustment parameter. In this configuration, the video connector support 23 does not turn with the handle 11. Thus, the handle 11 can be turned without any risk of the electrical power supply wires of the camera becoming twisted.

With reference to FIGS. 7 and 4, in this example, the handle 11 is provided with a second lug 29 that is radially offset relative to the above-mentioned first lug towards the axis of the handle 11, and the video connector support 23 is provided with a second notch 30 suitable for receiving the second lug 29 and for co-operating therewith so that the handle 11 turning causes the video connector support 23 to turn without causing the toothed wheel 20 to turn. Naturally, this configuration may be inverted, the video connector support being provided with the second lug and the handle being provided with the second notch. This construction makes it possible to use a lighting module of the invention in a configuration in which modulating the adjustment parameter is obtained by turning the handle 11, and in a second configuration in which the handle 11 turning has no effect on the adjustment parameter.

The lighting appliance 1 of the invention also includes a relative angular position sensor 31 (shown in FIGS. 2 and 3) that is in the form of a potentiometer card through which the axle of the pinion 26 passes. The angular position sensor 31 is suitable for emitting a signal indicating the relative angular position of the pinion 26 and thus of the handle 11. The angular position sensor 31 passes a current having its voltage varying as a function of the angular position of the pinion 26, e.g. over the range 0 to 5 volts.

In accordance with the invention, the monitoring and control unit 10 or “MCU” is coupled to the angular position sensor 31 and is programmed so that, at successive regular time intervals, it reads indications giving the relative angular positions of the pinion 26 and thus of the handle 11, and, on the basis of these successive readings, it modulates a particular adjustment parameter and/or changes adjustment parameter.

As appears below, the MCU 10 repeats a processing loop at each time interval for modulating the current adjustment parameter. The length of each time interval may, for example, be 5 milliseconds (ms), but it may be longer or shorter depending on the desired adjustment sensitivity.

As indicated above, the handle 11 turning may serve to cause a change of control or of adjustment parameter in the MCU 10, independently of any modulation of the adjustment parameter, e.g. going over from the control of the adjustment parameter P1 for the diameter of the illumination spot 3 to the control of the adjustment parameter P2 for the level of visual illumination.

It should be noted that, in the MCU 10, it is possible to have more than two controls or adjustment parameters that are actionable selectively, going over from one control or adjustment parameter to another taking place in a predetermined order P1, P2, P3, . . . Pn of a predetermined circular list of controls or of adjustment parameters.

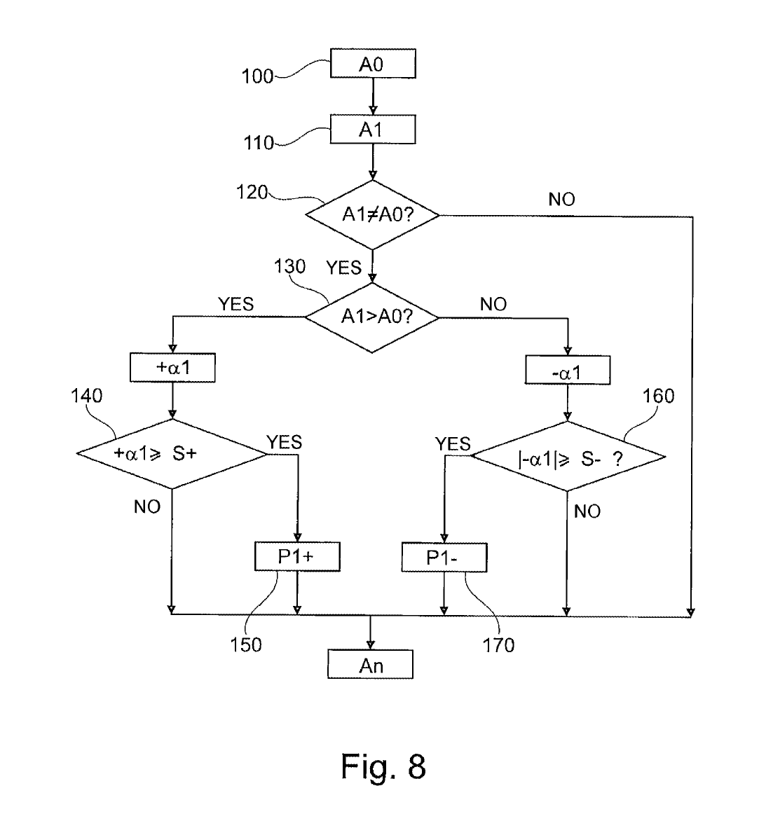

FIG. 8 shows the stage of switching ON the MCU 10 of the invention, and in particular the first modulation loop. In this example, it is considered that the MCU 10 starts with a predetermined current adjustment parameter P1, e.g. size of the illumination spot 3.

In step 100, the MCU 10 reads an initial indication giving the initial angular position A0 for the handle 11, this angular position being, for example, as shown in FIG. 5. This initial angular position A0 may also be the angular position stored in a memory when the MCU 10 was switched OFF the last time the lighting appliance 1 was used, or indeed it may correspond to a reference position in which the handle 11 is repositioned before any switching ON of the MCU 10.

At successive predetermined time intervals n, e.g. every 5 ms after switching ON at the step 100, the MCU 10 reads an indication of the current angular position of the handle 11, which position is, in this example, the first current angular position A1 such as, for example, shown in FIG. 6. This current angular position A1 is recorded in a memory in the MCU 10.

In step 120, the MCU 10 compares the current angular position A1 with the preceding angular position, i.e. the initial angular position A0, which is also stored in the memory of the MCU 10.

If, in step 120, the current angular position A1 is not different from the initial angular position A0, the MCU 10 keeps the value of the adjustment parameter P1 constant and the data processing process loops back for another time interval, which is 5 ms in length in this example. Otherwise, i.e. if, in step 120, the current angular position A1 is different from the initial angular position A0, the MCU 10 computes the angular difference al between the current angular position A1 and the initial angular position A0. In step 130, the MCU 10 also determines the turning direction (±α1) of the handle 11 between the initial angular position A0 and the current angular position A1, in particular the turning direction (+α1) if the turning direction of the handle 11 is clockwise and the turning direction (−α1) if the turning direction of the handle 11 is counterclockwise.

If, in step 130, the MCU 10 determines an angular difference +α1 that is not zero in the clockwise direction, then in step 140 the MCU 10 compares this angular difference +α1 with a first predetermined threshold S+ (clockwise threshold), it being possible for this clockwise threshold S+ to be recorded in a memory of the MCU 10 in order to be associated with the adjustment parameter P1. It should be understood that it is possible to have a plurality of different thresholds S+ associated with respective ones of different adjustment parameters that can be modulated in the MCU 10.

If, in step 140, the MCU 10 determines that the angular offset +α1 has a value less than the clockwise threshold S+, i.e. the handle 11 has not turned far enough clockwise, then the MCU 10 keeps the value of the adjustment parameter P1 constant, and the data processing process loops back for another time interval. Conversely, if, in step 140, the MCU 10 determines that the value of the angular difference +α1 is greater than (or equal to) the clockwise threshold S+, then, in step 150, the MCU 10 modulates (varies) the value of the adjustment parameter P1 in predetermined manner, and continues the processing for a new time interval. The variation of the adjustment parameter P1 is indicated at 150 by P1+. This variation may consist in gradually increasing the value, e.g. increasing the diameter for the illumination spot 3 by a centimeter.

If, in step 130, the MCU 10 determines an angular difference −α1 that is not zero in the counterclockwise direction, then in step 160 the MCU 10 compares this angular difference −α1 with a second predetermined threshold S− (counterclockwise threshold), it being possible for this counterclockwise threshold S− to be recorded in a memory of the MCU 10 in order also to be associated with the adjustment parameter P1.

It should be understood that it is possible to have a plurality of different clockwise and counterclockwise thresholds S+, S− associated with respective ones of different adjustment parameters that can be modulated in the MCU 10.

If, in step 160, the MCU 10 determines that the angular difference −α1 has a value less than the counterclockwise threshold S−, then the MCU 10 keeps the value of the adjustment parameter P1 constant, and the data processing process continues for a further time interval that starts running on expiry of the current time interval n. Conversely, if, in step 160, the MCU 10 determines that the value of the angular difference −α1 is greater than (or equal to) the counterclockwise threshold S−, then, in step 170, the MCU 10 modulates (varies) the value of the adjustment parameter P1 in predetermined manner, and continues the processing for a new time interval. The variation of the adjustment parameter P1 is indicated at 170 by P1−. This variation may consist in gradually decreasing the value, e.g. by decreasing the diameter for the illumination spot 3 by a centimeter.

It can be understood that the modulations in the steps 150 and 170 of the adjustment parameter P1 normally go in opposite directions (increase/decrease).

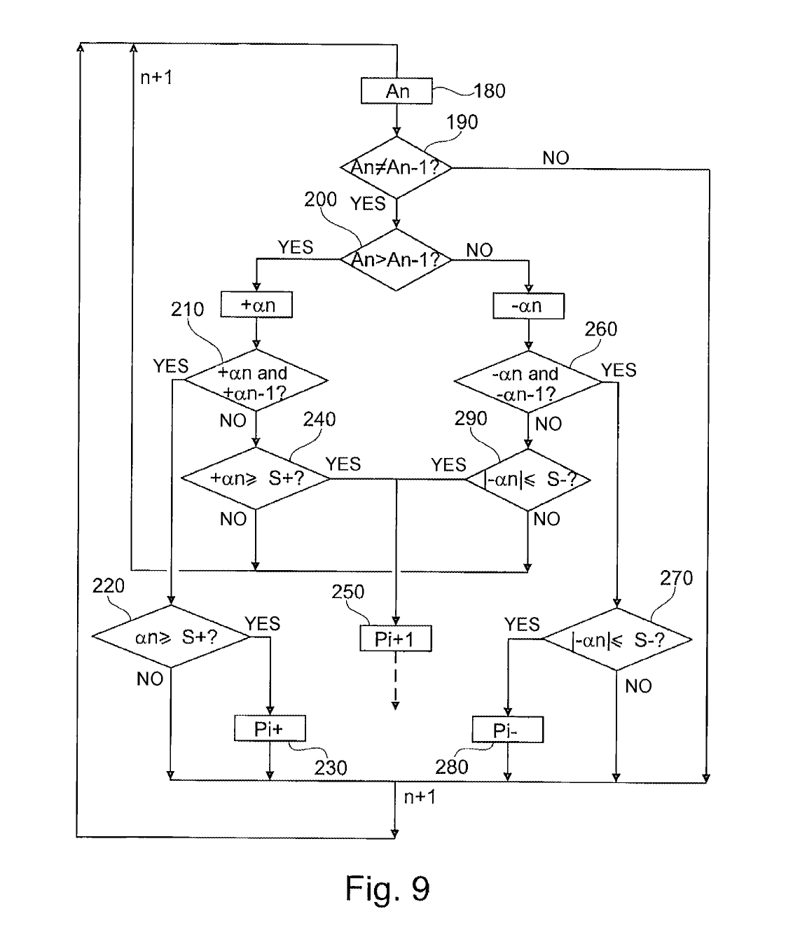

FIG. 9 shows a modulation loop subsequent to the first modulation loop shown in FIG. 8, i.e. subsequent to data processing in the MCU 10 that corresponds to the n^{th} time interval.

In step 180, the MCU 10 reads the current angular position An of the handle 11 and records it in the memory. In step 190, the MCU 10 compares the current angular position An with the preceding annular position An−1 of the handle 11 that has been kept in the memory in the MCU 10, i.e. the angular position occupied by the handle 11 at the end of the preceding time interval n−1, immediately before the current time interval n. If the current angular position An is identical to the preceding angular position An−1 of the handle 11, the MCU 10 keeps constant the current adjustment parameter that is activated in the MCU 10 and that is indicated by Pi, and the process continues over a new modulation loop for another time interval.

Otherwise, i.e. if, in step 90, the current angular position An is different from the preceding angular position An−1 of the handle 11, then, in step 200, the MCU 10 computes the angular difference an between the current angular position An and the preceding angular position An−1. In step 200, the MCU 10 also determines the turning direction of the handle 11 on going from the preceding angular position An−1 to the current angular position An, in particular the turning direction (+αn) if the turning direction of the handle 11 is clockwise, and the turning direction (−αn) if the turning direction of the handle 11 is counterclockwise. This current angular difference ±αn and the current turning direction are also recorded in step 200 in the memory by the MCU 10 at each current time interval n.

If, in step 200, the MCU 10 determines that the turning direction during the current time interval n is the clockwise turning direction (+αn), then, in step 210, the MCU 10 checks whether the preceding turning direction αn−1 during the preceding time interval n−1 was also a clockwise turning direction (+αn). If it is, then in step 220, the MCU 10 compares the current angular difference +αn with the predetermined clockwise threshold S+ associated with the current adjustment parameter Pi. If the value of the current angular difference +αn is less than the clockwise threshold S+, then the MCU 10 keeps the value of the adjustment parameter Pi constant (no adjustment action on the lighting appliance 1) and the process loops back for another time interval n+1. Conversely, if the value of the current angular difference +αn is greater than (or equal to) the clockwise threshold S+, then the MCU 10 varies (increments) the value of the adjustment parameter Pi as indicated above, and loops back for another time interval n+1.

If, in step 200, the MCU 10 detects a change of turning direction of the handle 11 both for the current time interval n and for the preceding time interval n−1, i.e. if the turning direction of the handle 11 for the preceding time interval n−1 was the counterclockwise direction (−αn−1), then, in step 240, the MCU 10 compares the current angular difference +αn with the clockwise threshold S+ associated with the current adjustment parameter Pi.

In step 240, if the value of the current angular difference +αn is less than the clockwise threshold S+, then the MCU 10 keeps the value of the adjustment parameter Pi constant (no variation of the parameter) and loops back for another time interval n+1, and, conversely, if the value of the current angular difference +αn is greater than (or equal to) the clockwise threshold S+, then the MCU 10 changes the adjustment parameter. In the example, the MCU 10 goes over to the adjustment parameter Pi+1 that, for example, corresponds to adjustment of the brightness of the illumination. The process then loops back for another time interval n+1.

If, in step 200, the MCU 10 determines that the turning direction during the current time interval n is the counterclockwise turning direction (−αn), then, in step 260, the MCU 10 checks whether the preceding turning direction αn−1 during the preceding time interval n−1 was also a counterclockwise turning direction (−αn−1). If it was, then in step 290, the MCU 10 compares the current angular difference −αn with the predetermined counterclockwise threshold S− associated with the current adjustment parameter Pi. If the value of the current angular difference −αn is less than the counterclockwise threshold S−, then the MCU 10 keeps the value of the adjustment parameter Pi constant (no adjustment action on the lighting appliance 1) and continues its processing for another time interval n+1. Conversely, if the value of the current angular difference −αn is greater than (or equal to) the counterclockwise threshold S−, then the MCU varies (decreases) the value of the adjustment parameter Pi, and loops back for another time interval n+1.

If, in step 260, the MCU 10 detects a change of turning direction of the handle 11 both for the current time interval n and for the preceding time interval n−1, i.e. if the turning direction of the handle 11 for the preceding time interval n−1 was the clockwise direction (+αn−1), then, in step 290, the MCU 10 compares the current angular difference −αn with the predetermined counterclockwise threshold S− associated with the current adjustment parameter Pi.

In step 290, if the value of the current angular difference −αn is less than the counterclockwise threshold S−, then the MCU 10 keeps the value of the adjustment parameter Pi constant (no variation of the parameter) and loops back for another time interval n+1, and, conversely, if the value of the current angular difference −αn is greater than (or equal to) the counterclockwise threshold S−, then the MCU 10 goes over to the adjustment parameter Pi+1, e.g. by following a circular list of adjustment parameters as indicated above, i.e. goes over to the adjustment parameter Pi+1. The process then loops back for another time interval n+1.

It can thus be understood that turning in one direction and in the other over two consecutive time intervals can be detected by the MCU 10, and can command parameter Pi to be changed being controlled by the handle 11 being turning.

It can also be understood that an adjustment parameter Pi is varied by turning the handle 11 in the same direction over two consecutive time intervals n−1 and n, and that such a variation tends to be of the incremental or gradual type. It is also possible to make provision for progressive rather than incremental gradation without going beyond the ambit of the invention.

Advantageously, particular counterclockwise thresholds S− and S+ may be assigned to each adjustment parameter Pi, it being possible for the counterclockwise threshold S− to be different from the clockwise threshold S+. It is thus possible to have as many pairs of counterclockwise and clockwise thresholds S− and S+ as there are adjustment parameters Pi under monitoring and control in the MCU 10.

By way of example, each of the counterclockwise and clockwise thresholds S− and S+ may be 45° but naturally if this threshold level is decreased, the sensitivity of the MCU 10 to monitoring and control of the adjustment parameter Pi is increased accordingly.

In accordance with the invention, modulating the adjustment parameter Pi does not depend on an absolute angular position of the handle 11 in the dome 7, but rather on a relative difference between angular positions of the handle 11, between a current position and a preceding position that it occupied during the preceding reading. Thus, because a threshold S is to be reached between these two angular positions before triggering any modulation in the adjustment parameter Pi, the lighting appliance 1 of the invention makes it possible to limit the sensitivity of the modulation control. The handle 11 can thus continue to be used for moving the dome 7 without causing any unintentional adjustment.

In addition, the absence of any physical abutment over the angular stroke of the handle 11 makes adjustment of the lighting appliance 1 operational at any time, as soon as the predetermined threshold S for turning of the handle 11 has been crossed. Finally, given the repeated modulation loops, modulation of the adjustment parameter Pi remains effective and precise.

The particular construction of the lighting device 1 of the invention makes it possible, in addition, for the angular position sensor 31 to be off-center relative to the axis of the handle 11. The handle 11 can thus be hollow and receive a vision device or any suitable device in it.

Naturally, the present invention is in no way limited to the above description of one of its embodiments, which can undergo modifications without going beyond the ambit of the invention.

1. A lighting appliance, in particular for illuminating an operating field, the lighting appliance comprising a light module having a handle mounted to turn, and a monitoring and control unit that responds to said handle turning by acting on an adjustment setting of said lighting appliance, said lighting appliance being characterized in that said monitoring and control unit is arranged to read, at successive regular time intervals (n−1, n), an indication of the relative angular position (An−1, An) of said handle, and to act on said adjustment setting on the basis of the indications of the current relative angular position (An) and of the preceding relative angular position (An−1) that are read respectively for a current time interval (n) and for a time interval (n−1) immediately preceding said current time interval (n), and in that said monitoring and control unit is arranged to compute a current angular difference (αn) on the basis of said indications of the current angular position (An) and of the preceding angular position (An−1), and to compare said current angular difference (αn) with a predetermined threshold (S±).

2. A lighting appliance according to claim 1, wherein said monitoring and control unit is arranged to modify the value of an adjustment parameter (Pi, Pi+1) of said lighting appliance when said current angular difference (αn) is greater than said threshold (S±).

3. A lighting appliance according to claim 2, wherein said monitoring and control unit is arranged to determine, at each current time interval (n), a direction for said current angular difference (+αn/+αn) and to increase or to decrease the value of the adjustment parameter (Pi, Pi+1) as a function of the direction of the current angular difference (+αn/+αn).

4. A lighting appliance according to claim 3, wherein said monitoring and control unit is arranged to compare said current angular difference (+αn/+αn) with a predetermined first threshold (S+) for a first turning direction (+αn) of said handle, and to compare said current angular difference (+αn/+αn) with a predetermined second threshold (S−) for a second turning direction (−αn) of said handle that is opposite from said first turning direction (+αn), said first threshold (S+) being different from said second threshold (S−).

5. A lighting appliance according to claim 1, wherein said monitoring and control unit is arranged to detect a change of turning direction of said handle during said current time interval (n) and said preceding time interval (n−1), and to respond to said detection by changing over the adjustment of said lighting appliance from a current adjustment parameter (Pi) to a predetermined adjustment parameter (Pi+1).

6. A lighting appliance according to claim 3, wherein said value of said adjustment parameter (Pi, Pi+1) is an illumination power, a color temperature, or a light spot size.

7. A lighting appliance according to claim 5, wherein said monitoring and control unit changes over from a current adjustment parameter (Pi) to another adjustment parameter (Pi+1) following a predetermined circular list of adjustment parameters.

8. A lighting appliance according to claim 1, wherein it has a toothed wheel that is on the same axis as said handle and that is constrained to turn with said handle, a pinion arranged to mesh with said toothed wheel, and a relative angular position sensor suitable for detecting the relative angular position of said handle via the relative angular position of said pinion.

9. A lighting appliance according to claim 8, wherein said angular position sensor is of the potentiometer type.

10. A lighting appliance according to claim 8, wherein said handle is hollow and is suitable for receiving a video connector support.
